(19) United States
(12) Patent Application Publication
(10) Pub. No.: US 2026/0313435 A1
(43) Pub. Date: Oct. 8, 2026

(54) LIMITED BUFFER RATE MATCHING FOR MULTICAST

(71) Applicant: QUALCOMM Incorporated, San Diego, CA (US)

(72) Inventors: Ayan SENGUPTA, Mountain View, CA (US); Alberto RICO ALVARINO, San Diego, CA (US); Javier RODRIGUEZ FERNANDEZ, San Diego, CA (US)

(21) Appl. No.: 19/575,488

(22) Filed: Mar. 23, 2026

Related U.S. Application Data
(60) Provisional application No. 63/783,791, filed on Apr. 4, 2025.

(51) Int. Cl. H04W 28/02; H04W 4/06

(52) U.S. Cl. CPC H04W 28/0231; H04W 4/06

(57) ABSTRACT

This disclosure provides methods, components, devices, and systems for limited buffer rate matching (LBRM) for multicast. A network entity may transmit an indication of a value associated with LBRM for multicast to multiple user equipments (UEs). The indication of the value may indicate one or more LBRM parameters for multicast, such as parameters associated with rate matching a multicast or broadcast message. The UEs may use the indication of the value to coordinate LBRM operations with the network entity. The network entity may transmit a multicast or broadcast message via the multicast channel based on a rate matching procedure in accordance with the indicated value (e.g., the LBRM parameters). The UEs may receive (e.g., successfully receive) the multicast or broadcast message based on a de-rate matching procedure that is also in accordance with the indicated value and, accordingly, corresponds to the rate matching procedure at the network entity.

### CROSS REFERENCES TO RELATED APPLICATIONS

The present Application for Patent claims the benefit of U.S. Provisional Patent Application No. 63/783,791 by SENGUPTA et al., entitled “LIMITED BUFFER RATE MATCHING FOR MULTICAST,” filed Apr. 4, 2025, assigned to the assignee hereof, and expressly incorporated by reference herein.

### TECHNICAL FIELD

This disclosure relates generally to wireless communication, and more specifically to systems, devices, methods, and techniques associated with limited buffer rate matching (LBRM) for multicast.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication at a user equipment (UE) is described. The method may include receiving an indication of one or more values associated with limited buffer rate matching (LBRM) for a multicast channel and receiving, via the multicast channel, a multicast or broadcast message, where the multicast or broadcast message is received based on de-rate matching the multicast or broadcast message based on the one or more values.

A UE for wireless communication is described. The UE may include a processing system that includes processor circuitry and memory circuitry that stores code. The processing system may be configured to cause the UE to receive an indication of a value associated with LBRM for a multicast channel and receive, via the multicast channel, a multicast or broadcast message, where the multicast or broadcast message is received based on de-rate matching the multicast or broadcast message based on the value.

Another UE for wireless communication is described. The UE may include means for receiving an indication of a value associated with LBRM for a multicast channel and means for receiving, via the multicast channel, a multicast or broadcast message, where the multicast or broadcast message is received based on de-rate matching the multicast or broadcast message based on the value.

A non-transitory computer-readable medium storing code for wireless communication is described. The code may include instructions executable by one or more processors to receive an indication of a value associated with LBRM for a multicast channel and receive, via the multicast channel, a multicast or broadcast message, where the multicast or broadcast message is received based on de-rate matching the multicast or broadcast message based on the value.

Some examples of the method, UEs, and non-transitory computer-readable medium described herein may further include operations, features, means, or instructions for selecting one or more de-rate matching parameters based on the indication of the value, where the multicast or broadcast message may be received further based on the one or more de-rate matching parameters.

In some examples of the method, UEs, and non-transitory computer-readable medium described herein, the value includes at least one of a total quantity of soft channel bits, or a first soft buffer size associated with a transport block (TB), or a second soft buffer size associated with a code block (CB) of the TB, or a threshold transport block size (TBS) associated with the LBRM, or a threshold coding rate associated with the LBRM. Some examples of the method, UEs, and non-transitory computer-readable medium described herein may further include operations, features, means, or instructions for setting a soft buffer size equal to at least one of the first soft buffer size or the second soft buffer size, where the de-rate matching the multicast or broadcast message may be based on the soft buffer size. Some examples of the method, UEs, and non-transitory computer-readable medium described herein may further include operations, features, means, or instructions for calculating a soft buffer size based on at least one of the total quantity of soft channel bits, or the first soft buffer size, or the second soft buffer size, or the threshold TBS, or the threshold coding rate, where the de-rate matching the multicast or broadcast message may be based on the soft buffer size.

In some examples of the method, UEs, and non-transitory computer-readable medium described herein, the indication of the value may be received via at least one of a system information block (SIB), or a multicast control channel (MCCH) message, or a multicast channel scheduling information (MSI) medium access control (MAC) control element (CE) message.

A method for wireless communication at a network entity is described. The method may include transmitting an indication of a value associated with LBRM for a multicast channel and transmitting, via the multicast channel, a multicast or broadcast message, where the multicast or broadcast message is transmitted based on rate matching the multicast or broadcast message based on the value.

A network entity for wireless communication is described. The network entity may include a processing system that includes processor circuitry and memory circuitry that stores code. The processing system may be configured to cause the network entity to transmit an indication of a value associated with LBRM for a multicast channel and transmit, via the multicast channel, a multicast or broadcast message, where the multicast or broadcast message is transmitted based on rate matching the multicast or broadcast message based on the value.

Another network entity for wireless communication is described. The network entity may include means for transmitting an indication of a value associated with LBRM for a multicast channel and means for transmitting, via the multicast channel, a multicast or broadcast message, where the multicast or broadcast message is transmitted based on rate matching the multicast or broadcast message based on the value.

A non-transitory computer-readable medium storing code for wireless communication is described. The code may include instructions executable by one or more processors to transmit an indication of a value associated with LBRM for a multicast channel and transmit, via the multicast channel, a multicast or broadcast message, where the multicast or broadcast message is transmitted based on rate matching the multicast or broadcast message based on the value.

Some examples of the method, network entities, and non-transitory computer-readable medium described herein may further include operations, features, means, or instructions for selecting one or more rate matching parameters based on the value, where the multicast or broadcast message may be transmitted further based on the one or more rate matching parameters.

In some examples of the method, network entities, and non-transitory computer-readable medium described herein, the value includes at least one of a total quantity of soft channel bits, or a first soft buffer size associated with a TB, or a second soft buffer size associated with a CB of the TB, or a threshold TBS associated with the LBRM, or a threshold coding rate associated with the LBRM.

In some examples of the method, network entities, and non-transitory computer-readable medium described herein, the indication of the value may be transmitted via at least one of an SIB, or an MCCH message, or an MSI MAC-CE message.

Some examples of the method, network entities, and non-transitory computer-readable medium described herein may further include operations, features, means, or instructions for scaling a TBS for the multicast channel based on a first factor and interleaving a quantity of TBs in a time domain based on a second factor, where the multicast or broadcast message may be transmitted based on the scaling and the interleaving.

### BRIEF DESCRIPTION OF THE DRAWINGS

FIG. 1 shows an example of a wireless communication system.

FIG. 2 shows an example of a signaling configuration that supports limited buffer rate matching (LBRM) for multicast.

FIG. 3 shows an example of a process flow that supports LBRM for multicast.

FIG. 4 shows a block diagram of a processing system that supports LBRM for multicast.

FIG. 5 shows a diagram of a system including a device that supports LBRM for multicast.

FIG. 6 shows a block diagram of a processing system that supports LBRM for multicast.

FIG. 7 shows a diagram of a system including a device that supports LBRM for multicast.

FIGS. 8 and 9 show flowcharts illustrating methods that support LBRM for multicast.

Details of aspects of the subject matter in this disclosure are set forth in the drawings and accompanying descriptions. Like reference numbers and designations in the various drawings indicate like elements.

Additional disclosure and examples related to the present description are provided in the attached appendix.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may transmit a message to multiple user equipments (UEs) via multicast or broadcast signaling. In some examples, the network entity may interleave multiple transport blocks (TBs) in the time domain for transmission via a multicast channel. For example, the network entity may time-interleave M TBs in a multicast or broadcast message. Additionally, or alternatively, the network entity may scale transport block sizes (TBSs) for the TBs according to a factor, N. For example, the network entity may scale a TB by a factor of N and spread the scaled TB over N discontinuous units in the time domain (e.g., across subframes or symbols to improve time diversity). The values of N and M may significantly affect the signaling overhead (e.g., a total quantity of code blocks (CBs) based on the scaling and time-interleaving) associated with the multicast or broadcast message transmission. For example, some network entities may interleave thirty-two TBs (e.g., M=32) and may scale the TBs by a factor of sixteen (e.g., N=16). One or more UEs may fail to support a resulting size (e.g., TBS, quantity of CBs) of the multicast or broadcast message based on the values of N and M causing the resulting size to exceed a UE capability (e.g., a soft buffer size or other UE capability). Accordingly, one or more UEs may fail to support a multicast channel with time-interleaving, reducing the ability of the one or more UEs to efficiently and reliably receive multicast or broadcast messages.

Aspects of the subject matter described in this disclosure relate to limited buffer rate matching (LBRM) for multicast. For example, UEs may implement LBRM for multicast to support a multicast channel with time-interleaving. A network entity may transmit signaling that enables multiple UEs to support LBRM via a multicast channel. The network entity may transmit an indication of a value associated with LBRM for the multicast channel to the multiple UEs. For example, the network entity may transmit a signal that indicates one or more parameters associated with LBRM, such as a total quantity of soft channel bits, N_{soft}, a first soft buffer size associated with a TB, N_{IR}, a second soft buffer size associated with a CB of the TB, N_{cb}, a threshold TBS associated with LBRM, a threshold coding rate associated with LBRM, or any combination thereof. The signal may be an example of at least one of a system information block (SIB), a multicast control channel (MCCH) message, or a multicast channel scheduling information (MSI) medium access control (MAC) control element (CE) message. Multiple UEs may receive the signal and determine the value (e.g., the one or more parameters) associated with LBRM for the multicast channel. The network entity may perform rate matching in accordance with the value (e.g., the one or more parameters) for a multicast or broadcast message and may transmit the multicast or broadcast message via the multicast channel based on the rate matching. The UEs may receive the multicast or broadcast message and may de-rate match the multicast or broadcast message in accordance with the indicated value (e.g., the one or more parameters). In some examples, the UEs may successfully receive the multicast or broadcast message based on de-rate matching and decoding the multicast or broadcast message.

Particular aspects of the subject matter described in this disclosure can be implemented to realize one or more improvements to multicast signaling. In some examples, by communicating the indication of the value (e.g., the one or more parameters) associated with LBRM for the multicast channel, the described techniques can be used to enable LBRM for multicast. For example, the network entity may coordinate the one or more parameters associated with LBRM for multicast to multiple UEs, such that the network entity and the multiple UEs may coordinate rate matching and de-rate matching for a multicast or broadcast message. Additionally, or alternatively, by enabling LBRM for multicast, the network entity may improve a message size (e.g., a TBS or quantity of CBs) supported for multicast or broadcast messages, reducing the latency involved in UEs receiving multicast or broadcast information.

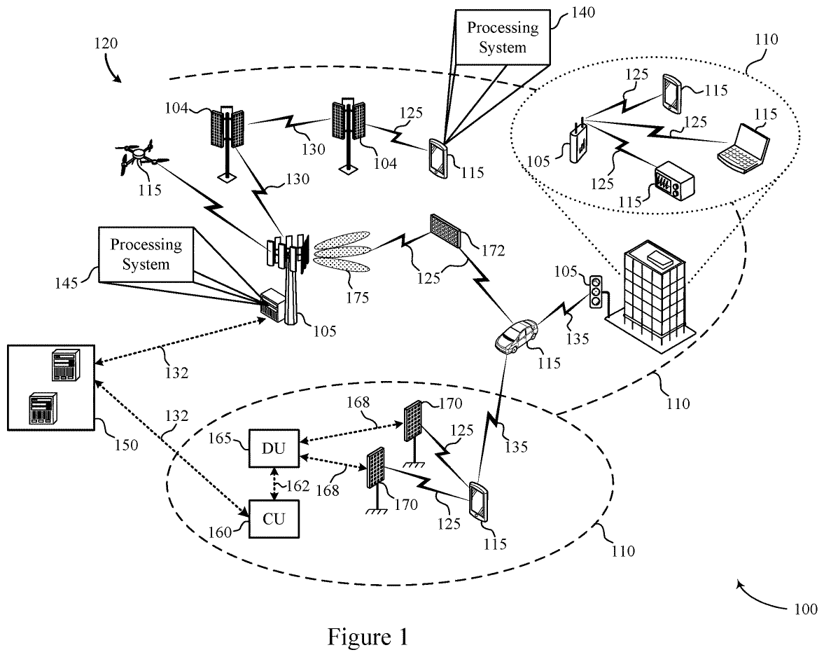

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information

(DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The wireless communication system 100 may support LBRM techniques. LBRM may involve using a reduced buffer size for rate matching and de-rate matching operations. In some implementations, wireless devices may support LBRM for some channel types but not others. For example, a network entity 105 and a UE 115 may support LBRM for downlink unicast transmissions (e.g., via a downlink shared channel (DL-SCH) or a paging channel (PCH)). However, the network entity 105 and the UE 115 may fail to support (or otherwise refrain from supporting) LBRM for uplink unicast transmissions (e.g., via an uplink shared channel (UL-SCH)) and sidelink transmissions (e.g., via a sidelink shared channel (SL-SCH) or a sidelink data channel (SL-DCH)).

To support LBRM for downlink unicast transmissions, the UE 115 may transmit a UE capability message to the network entity 105 that indicates a total number of soft channel bits, N_{soft}, supported by the UE 115. For example, a UE category of the UE 115 may correspond to a quantity of soft channel bits supported by the UE 115. The UE capability message may indicate an indication of the UE category, and the network entity 105 may determine the value of N_{soft} for the UE 115 based on the indicated UE category.

The network entity 105 may select a size of a soft buffer for rate matching a transmission for the UE 115 based on the value of N_{soft}. A soft buffer may be an example of a buffer that stores soft bit decisions (e.g., log-likelihood ratios (LLRs) or other indicators supporting bit value prediction). The network entity 105 may select a soft buffer size for a TB, N_{IR}, based on the value of N_{soft} (e.g., among other parameters). Additionally, or alternatively, the network entity 105 may select a soft buffer size for a CB (e.g., for the r^{th} CB of a set of CBs), N_{cb}, based on the soft buffer size for the TB and the quantity of CBs. The network entity 105 may determine a set of information bits for transmission to the UE 115. The network entity 105 may encode the set of information bits (e.g., via channel encoding) to determine an encoded set of bits (e.g., indicating the information bits using information bits, parity bits, frozen bits, or any other types of bits). The network entity 105 may rate match the encoded set of bits to available resources using the selected soft buffer size. For example, the network entity 105 may load the encoded set of bits into a buffer (e.g., a circular buffer of the soft buffer size) and may perform rate matching using the encoded set of bits loaded into the buffer. The network entity 105 may transmit the resulting rate-matched encoded bits as a message.

The UE 115 may receive the message and may de-rate match the message based on the same soft buffer size. For example, because the network entity 105 and the UE 115 coordinated the value of N_{soft} for the UE 115, the network entity 105 and the UE 115 may determine a same rate matching process for the message. Accordingly, the UE 115 may perform de-rate matching using a same soft buffer size (e.g., a circular buffer with the soft buffer size used by the network entity 105) to correctly determine the encoded bits from the rate-matched encoded bits of the message. For example, the UE 115 may determine LLRs for the received bits and may load the LLRs into a soft buffer with the soft buffer size. The UE 115 may perform channel decoding to decode the encoded bits and determine the set of information bits conveyed by the network entity 105.

Additionally, or alternatively, the wireless communication system 100 may support time-interleaving for multicast channels. For example, a network entity 105 may interleave multiple TBs (e.g., M TBs) in the time domain for transmission via a multicast channel. Additionally, or alternatively, the network entity 105 may scale a TB by a factor of N and spread the scaled TB over N discontinuous units in the time domain (e.g., across subframes or symbols to improve time diversity). The values of N and M may significantly affect the signaling overhead (e.g., a total quantity of CBs based on the scaling and time-interleaving) associated with a multicast or broadcast message transmission via the multicast channel. For example, the network entity 105 may interleave thirty-two TBs (e.g., M=32) and may scale the TBs by a factor of sixteen (e.g., N=16). The network entity 105 may transmit the resulting multicast or broadcast message (e.g., with a TBS greater than a threshold value) to multiple UEs 115.

To support the size of the resulting multicast or broadcast message, the UEs 115 and the network entity 105 may support LBRM for the multicast channel (e.g., with time-interleaving). For example, the UEs 115 and the network entity 105 may select a soft buffer size for the multicast or broadcast message transmission to manage (e.g., handle, or otherwise support) the size of the multicast or broadcast message. However, the multicast or broadcast message is transmitted to multiple UEs 115, where different UEs 115 (e.g., UEs corresponding to different types, categories, or capabilities) may, in some examples, support different parameters for LBRM (e.g., different values of N_{soft}, N_{IR}, N_{cb}, or any combination of these or other LBRM parameters). If a UE 115 selects a soft buffer size or other de-rate matching parameters for LBRM for multicast based on the UE's own type, category, or capability, the UE 115 may fail to successfully receive the multicast or broadcast message, for example, based on multiple UEs 115 with different types, categories, or capabilities receiving the same multicast or broadcast message. That is, the network entity 105 may perform rate matching for the multicast or broadcast message using a set of LBRM parameters associated with a subset of the UEs 115 or associated with a candidate UE capability or candidate UE category (which may or may not correspond to any UEs 115 receiving the multicast or broadcast message).

To enable LBRM for multicast, the network entity 105 and the UEs 115 may coordinate LBRM parameters via signaling (e.g., control signaling). For example, the network entity 105 may transmit a signal to the UEs 115 that indicates at least one value associated with LBRM for multicast. The UEs 115 may receive the indication and may determine the LBRM parameters to use based on the indication.

Devices of the wireless communication system 100 may be configured to support one or more aspects of the described techniques for LBRM for multicast. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support improved coordination of LBRM parameters between a network entity 105 and multiple UEs 115 to support LBRM for multicast.

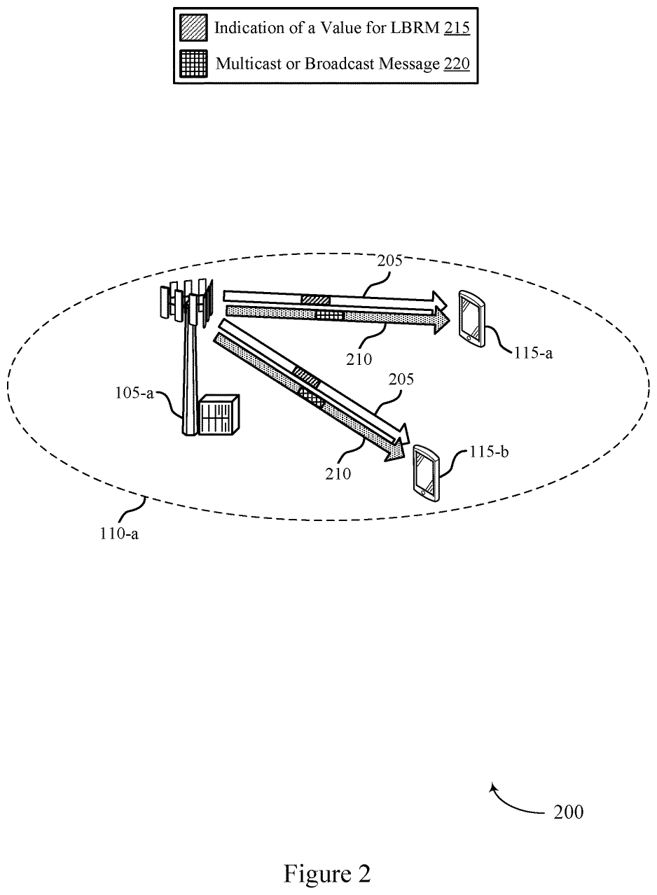

FIG. 2 shows an example of a signaling configuration 200 that supports LBRM for multicast. A wireless communication system, such as the wireless communication system 100, may support the signaling configuration 200. A network entity 105-a, which may be an example of a network entity 105 as described with reference to FIG. 1, may provide network coverage for a coverage area 110-a. The network entity 105-a may transmit multicast signaling to multiple UEs 115, such as a UE 115-a and a UE 115-b, which may be examples of UEs 115 as described with reference to FIG. 1. The network entity 105-a may transmit signaling that enables the UEs 115 to perform LBRM for a multicast channel 210.

In some examples, the network entity 105-a may support UEs 115 with different UE capabilities within the coverage area 110-a. For example, the first UE 115-a may be a first type of UE (e.g., a UE corresponding to first category or a first capability), and the second UE 115-b may be a second type of UE (e.g., a UE corresponding to second category or a second capability) different from the first type of UE.

The network entity 105-a may transmit an indication 215 of a value for LBRM for multicast to the UE 115-a and the UE 115-b. For example, the network entity 105-a may transmit a signal that includes the indication 215 of the value. In some examples, the signal or the indication 215 may indicate multiple values associated with LBRM for multicast (e.g., multiple LBRM parameters). The signal may be an example of a SIB, an MCCH message, an MSI MAC-CE message, or any other control signaling. For example, the network entity 105-a may transmit the signal including the indication 215 of the value via a first channel 205, which may be an MCCH, a physical downlink control channel (PDCCH), a physical broadcast channel (PBCH), or any other channel.

The UE 115-a and the UE 115-b may receive the indication 215 of the value for LBRM for multicast and may determine one or more LBRM parameters based on the indication 215 of the value. For example, the UE 115-a and the UE 115-b may determine a rate matching procedure to be performed at the network entity 105-a based on the indication 215 of the value. The UE 115-a and the UE 115-b may select a de-rate matching procedure to align with the rate matching procedure to be performed at the network entity 105-a.

As an example, the indication 215 of the value may indicate a total quantity of soft channel bits, N_{soft}, a first soft buffer size associated with a TB, N_{IR}, a second soft buffer size associated with a CB of the TB, N_{cb}, or any combination of these or other LBRM parameters. If the indication 215 of the value indicates an N_{soft} value, the UEs 115 may determine the first soft buffer size associated with the TB, N_{IR}, according to Equation 1.

$${N}_{IR} = ⌊ \frac{α \cdot {N}_{soft}}{{K}_{C} \cdot {K}_{MIMO} \cdot min ( {M}_{DL\_HARQ} , {M}_{limit )}} ⌋ \qquad ( 1 )$$

In Equation 1, the coefficient α may be 1 for a subframe duration, 1/2 for a slot duration, or 1/6 for a subslot duration of the multicast or broadcast transmission. The value of K_{C} may be associated with carrier aggregation, the value of N_{soft}, or both. For example, K_{C} may be set to 5, 32, 3/2, 2, 8/5, 8/3, 12/5, 6/5, 1, or some other value. The value of K_{MIMO} may be associated with a transmission mode or MIMO mode for the multicast or broadcast transmission. For example, K_{MIMO} may be set to 1 or 2. The value of M_{DL_HARQ} may be associated with a threshold quantity (e.g., maximum number) of DL HARQ processes for the multicast or broadcast transmission. The value of Mₗᵢₘᵢₜ may be a configured threshold, such as a constant value of 8.

If the UEs 115 calculate N_{IR} based on N_{soft} or the indication 215 of the value indicates an N_{IR} value, the UEs 115 may determine the second soft buffer size associated with a CB (e.g., an r^{th} CB) of the TB, N_{cb}, according to Equation 2.

$${N}_{cb} = min ( ⌊ \frac{{N}_{IR}}{C} ⌋ , {K}_{W} ) \qquad ( 2 )$$

In Equation 2, the value of C may be the quantity of CBs in the TB. The value of K_{W} may indicate a circular buffer length (e.g., a threshold, such as a maximum, circular buffer size of the soft buffer for the CB). In some examples, the value of K_{W} may scale with the TBS. For example, K_{W} may be three times the quantity of information bits in the TB. N_{soft}, N_{IR}, and N_{cb} may each be defined as a quantity of bits. For example, N_{IR} and N_{cb} may indicate soft buffer sizes as quantities of bits that can be loaded into the buffer.

The network entity 105-a and the UEs 115 may use the indication 215 of the value to perform LBRM for multicast. For example, the network entity 105-a may encode a set of information bits and may rate match the encoded bits based on (e.g., using) a soft buffer size indicated by N_{soft}, N_{IR}, N_{cb}, or some combination thereof. The network entity 105-a may transmit the resulting multicast or broadcast message 220 via a multicast channel 210 (e.g., a multicast or broadcast channel). The UE 115-a and the UE 115-b may receive the multicast or broadcast message 220 via the multicast channel 210. In some examples the UE 115-a and the UE 115-b may receive (e.g., successfully receive) the multicast or broadcast message 220 based on de-rate matching the multicast or broadcast message 220, decoding the multicast or broadcast message 220, or both.

The UE 115-a and the UE 115-b may de-rate match the multicast or broadcast message 220 based on (e.g., using) a soft buffer size indicated by N_{soft}, N_{IR}, N_{cb}, or some combination thereof (e.g., based on the indication 215 of the value). The UE 115-a and the UE 115-b may determine the set of information bits based on successfully receiving the multicast or broadcast message 220.

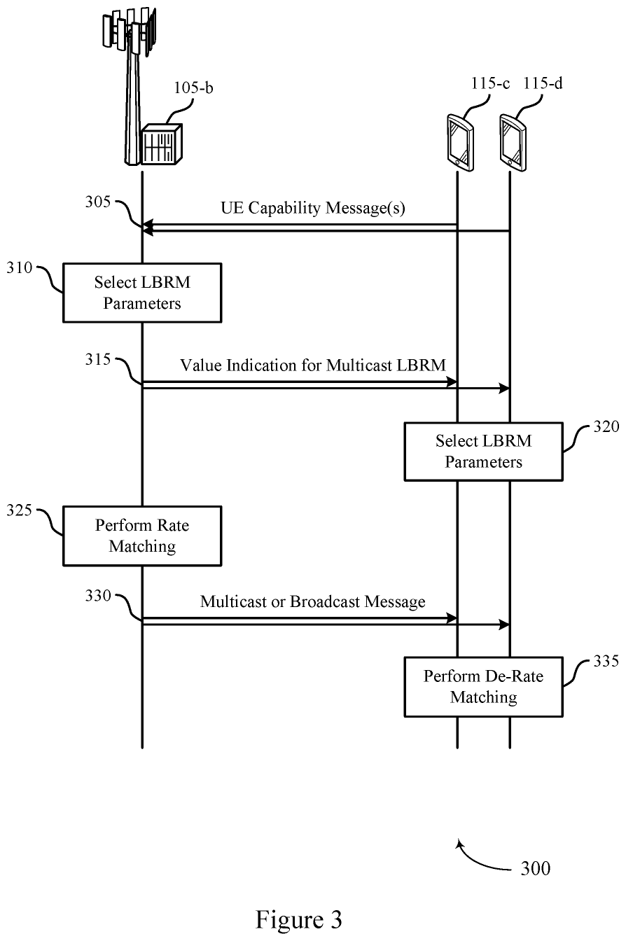

FIG. 3 shows an example of a process flow 300 that supports LBRM for multicast. The process flow 300 may be performed by aspects of the wireless communication system 100 or the signaling configuration 200, as described herein with reference to FIGS. 1 and 2. For example, multiple UEs 115, such as a UE 115-c and a UE 115-d, which may be examples of UEs 115 described with reference to FIGS. 1 and 2, and a network entity 105-b, which may be an example of a network entity 105 described with reference to FIGS. 1 and 2, may perform aspects of the process flow 300. The network entity 105-b may transmit signaling to the UEs 115 to enable LBRM for multicast at the UEs 115. For example, the network entity 105-b may mitigate ambiguity for LBRM by indicating, via some form of control signaling, parameters (e.g., rate matching parameters or other parameters) to the UEs 115 for LBRM for multicast.

In the following description of the process flow 300, operations performed by the network entity 105-b, the UE 115-c, and the UE 115-d may be performed in a different order than is shown. Some operations may be omitted from the process flow 300, and other operations may be added to the process flow 300. Further, although some operations or signaling may be shown to occur at different times for discussion purposes, these operations may occur at the same time. Additionally, or alternatively, other wireless devices may perform aspects of the process flow 300.

In some examples, at 305, the UEs 115 may transmit capability messages to the network entity 105-b. For example, the first UE 115-c may transmit a first UE capability message and the second UE 115-d may transmit a second UE capability message. In some implementations, the first UE 115-c and the second UE 115-d may be different categories of UEs with different rate matching (e.g., de-rate matching) capabilities. Based on the different UE categories, the first UE 115-c may support a first total number of soft channel bits, N_{soft,1}, according to a first UE category of the first UE 115-c, and the second UE 115-d may support a second total number of soft channel bits, N_{soft,2}, according to a second UE category of the second UE 115-d. For example, N_{soft,1} may equal 35982720 for the first UE 115-c and N_{soft,2} may equal 14616576 for the second UE 115-d. Other values of N_{soft} may be supported for other categories of UEs 115 (e.g., 47431680, 303562752, 19488768, 7308288, 3654144, or any other value). The capability messages may indicate the respective UE categories (e.g., using a UE category subfield, such as ue-Category or a version-specific UE category subfield), and the respective UE categories may indicate the respective values of N_{soft}. Accordingly, the network entity 105-b may receive multiple UE capability messages from multiple UEs 115. The network entity 105-b may determine (e.g., identify) total numbers of soft channel bits supported by UEs 115 based on (e.g., indicated by) the UE capability messages.

In some examples, at 310, the network entity 105-b may select one or more LBRM parameters for multicast transmission. In some implementations, the network entity 105-b may select the one or more LBRM parameters based on one or more UE capability messages received at 305. For example, the network entity 105-b may select an LBRM parameter that corresponds to a UE category or capability indicated by at least one UE capability message received at 305. Alternatively, the network entity 105-b may select an LBRM parameter that corresponds to a candidate UE category or candidate UE capability that may or may not correspond to any actual UE 115 that is to receive the multicast or broadcast message. For example, the network entity 105-b may select an LBRM parameter that is not indicated by any UE capability message received at 305. In some examples, the LBRM parameters may include rate matching parameters. For example, the one or more LBRM parameters may include one or more of: a total quantity of soft channel bits, N_{soft}; a first soft buffer size associated with a TB, N_{IR}; a second soft buffer size associated with a CB, N_{cb}; a threshold TBS for LBRM; or a threshold coding rate (e.g., a coding rate of 2/3) for LBRM.

At 315, the network entity 105-b may transmit an indication of a value (e.g., at least one value) associated with LBRM for a multicast channel. For example, the network entity 105-b may transmit control signaling that indicates (e.g., via the value) the rate matching parameters selected for multicast transmission. The value may be the total quantity of soft channel bits, N_{soft}, the first soft buffer size associated with a TB, N_{IR}, the second soft buffer size associated with a CB, N_{cb}, the threshold TBS for LBRM, the threshold coding rate for LBRM, or any combination thereof. The UE 115-c and the UE 115-d may receive the control signaling including the indication of the value (e.g., at least one value) associated with LBRM for the multicast channel.

In some examples, the control signaling may indicate the value using a UE category or capability. For example, the control signaling may indicate a UE category X (e.g., a candidate UE category). The UEs 115 may use the N_{soft} value that corresponds to the UE category X (e.g., even if a UE 115 does not itself correspond, or belong, to the UE category X).

In some other examples, the control signaling may directly indicate a numerical value for an LBRM parameter. For example, the control signaling may include a subfield or other bit field that includes a bit value indicating the numerical value for the LBRM parameter. For example, the control signaling may include an N_{soft} field, an N_{IR} field, an N_{cb} field, a threshold TBS for LBRM field (e.g., a TBS^{LBRM} value), a threshold coding rate for LBRM field (e.g., an R^{LBRM} value), or any combination of these or other LBRM fields. The UEs 115 may use the indicates value(s) to determine a soft buffer size for rate matching (e.g., de-rate matching). For example, the UEs 115 may use N_{soft}, N_{IR}, N_{cb}, Equation 1, Equation 2, or any combination thereof to calculate a soft buffer size. Additionally, or alternatively, the UEs 115 may determine (e.g., calculate) a soft buffer size for a total quantity of coded bits for a TB according to Equation 3.

$$soft buffer size = \frac{{TBS}^{LBRM}}{{R}^{LBRM}} \qquad ( 3 )$$

In yet some other examples, the control signaling may indicate the value based on a lookup table. For example, the network entity 105-b and the UEs 115 may be configured with a lookup table. The control signaling may indicate an index value. The UEs 115 may determine the value in the lookup table that corresponds to the indicated index value. For example, the lookup table may support values of N_{soft}, N_{IR}, N_{cb}, TBS^{LBRM}, R^{LBRM}, or any combination of these or other LBRM parameters.

Additionally, or alternatively, the indication of the value (e.g., at least one value) may correspond to a specific physical multicast channel (PMCH) or multimedia broadcast multicast service (MBMS) session. For example, the control signaling may indicate a first value associated with LBRM for a first PMCH. In such an example, the first value may apply to multiple MBMS sessions within the first PMCH. In some implementations, the control signaling may indicate a second value associated with LBRM for a second PMCH. In some other examples, the control signaling may indicate a first value associated with LBRM for a first MBMS session. In some implementations, the control signaling may indicate a second value associated with LBRM for a second MBMS session (e.g., that may be within the same PMCH as the first MBMS session). Accordingly, the network entity 105-b may support granular configurations of LBRM parameters for multicast. In some examples, UEs 115 may be configured with LBRM parameters or may communicate via a PMCH or MBMS session based on UE categories or capabilities. For example, the network entity 105-b may assign LBRM parameters for a first PMCH or MBMS session that a first subset of UEs 115 support but a second subset of UEs 115 do not support. The first subset of UEs 115 may receive multicast or broadcast signaling via the first PMCH or MBMS session using the LBRM parameters. In some implementations, the network entity 105-b may further assign LBRM parameters for a second PMCH or MBMS session that a different subset (or set) of UEs 115 support, such that different UEs 115 may use different PMCHs or MBMS sessions for LBRM based on the type, category, or capabilities of the UEs 115.

The control signaling may be an example of a SIB, an MCCH message, an MSI MAC-CE message, or any other control message. In some examples, the MSI MAC-CE message may include session-specific information, such that the MSI MAC-CE message may indicate one or more values specific to an MBMS session. The SIB, the MCCH message, or both may indicate one or more values common across multicast operations or a multicast channel. Additionally, or alternatively, the SIB, the MCCH message, or both may include session-specific elements and may indicate one or more values specific to an MBMS session using one or more session-specific elements.

In some examples, at 320, the UE 115-c and the UE 115-d may select one or more LBRM parameters based on the indication of the value. For example, the UE 115-c and the UE 115-d may determine one or more de-rate matching parameters for LBRM for multicast based on the control signaling indicating one or more LBRM parameters.

At 325, the network entity 105-b may perform rate matching based on the indicated value (e.g., the selected one or more LBRM parameters). At 330, the network entity 105-b may transmit a multicast or broadcast message via the multicast channel based on the rate matching. The UE 115-c and the UE 115-d may receive the multicast or broadcast message via the multicast channel. At 335, the UE 115-c and the UE 115-d may perform de-rate matching based on the indicated value (e.g., the selected one or more LBRM parameters). In some examples, the UE 115-c and the UE 115-d may receive the multicast or broadcast message via the multicast channel at 330 based on performing the de-rate matching according to the indicated value.

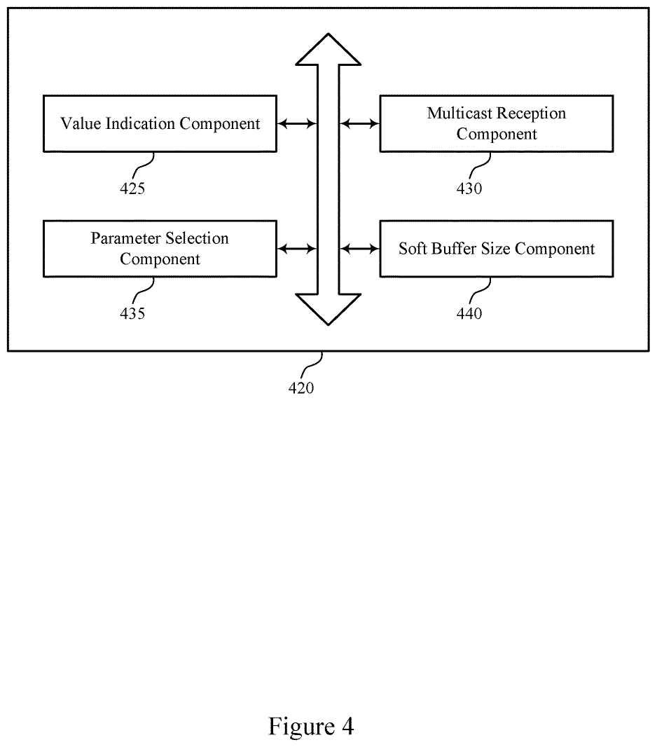

FIG. 4 shows an example of a processing system 420 that supports LBRM for multicast. A processing system 420 may be an example of a processing system 140 (such as of a UE 115) and may include a value indication component 425, a multicast reception component 430, a parameter selection component 435, a soft buffer size component 440, or any combination thereof. A processing system 420, or various component thereof, may be an example of means for performing (such as a means for causing a UE 115 to perform) various techniques described herein.

The value indication component 425 may be configured to cause the UE 115 to receive an indication of a value associated with LBRM for a multicast channel. The multicast reception component 430 may be configured to cause the UE 115 to receive, via the multicast channel, a multicast or broadcast message, where the multicast or broadcast message is received based on de-rate matching the multicast or broadcast message based on the value.

In some examples, the parameter selection component 435 may be configured to cause the UE 115 to select one or more de-rate matching parameters based on the indication of the value, where the multicast or broadcast message is de-rate matched further based on the one or more de-rate matching parameters.

In some examples, the value includes at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.

In some examples, the soft buffer size component 440 may be configured to cause the UE 115 to set a soft buffer size equal to at least one of the first soft buffer size or the second soft buffer size, where the de-rate matching the multicast or broadcast message is based on the soft buffer size.

In some examples, the soft buffer size component 440 may be configured to cause the UE 115 to calculate a soft buffer size based on at least one of the total quantity of soft channel bits, or the first soft buffer size, or the second soft buffer size, or the threshold TBS, or the threshold coding rate, where the de-rate matching the multicast or broadcast message is based on the soft buffer size.

In some examples, the indication of the value includes a subfield with a bit value that indicates the value.

In some examples, the indication of the value includes at least one of a first indication associated with a candidate UE category or a second indication associated with a candidate UE capability.

In some examples, the UE is associated with at least one of a first UE category different from the candidate UE category or a first UE capability different from the candidate UE capability.

In some examples, the indication of the value includes an index value. In some examples, the index value indicates the value based on a lookup table.

In some examples, the indication of the value is associated with a first physical multicast channel and the multicast channel includes the first physical multicast channel. In some examples, the indication of the value is associated with a first multimedia broadcast multicast service session and the multicast or broadcast message is associated with the first multimedia broadcast multicast service session.

In some examples, the value indication component 425 may be configured to cause the UE 115 to receive a second indication of a second value associated with the LBRM for at least one of a second physical multicast channel or a second multimedia broadcast multicast service session, where the second value is different from the first value.

In some examples, the indication of the value is received via at least one of a SIB, or an MCCH message, or an MSI MAC-CE message.

In some examples, the multicast or broadcast message is interleaved in a time domain based on a set of time interleaving parameters.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for improved communication reliability, reduced latency, more efficient utilization of communication resources, and improved coordination between devices.

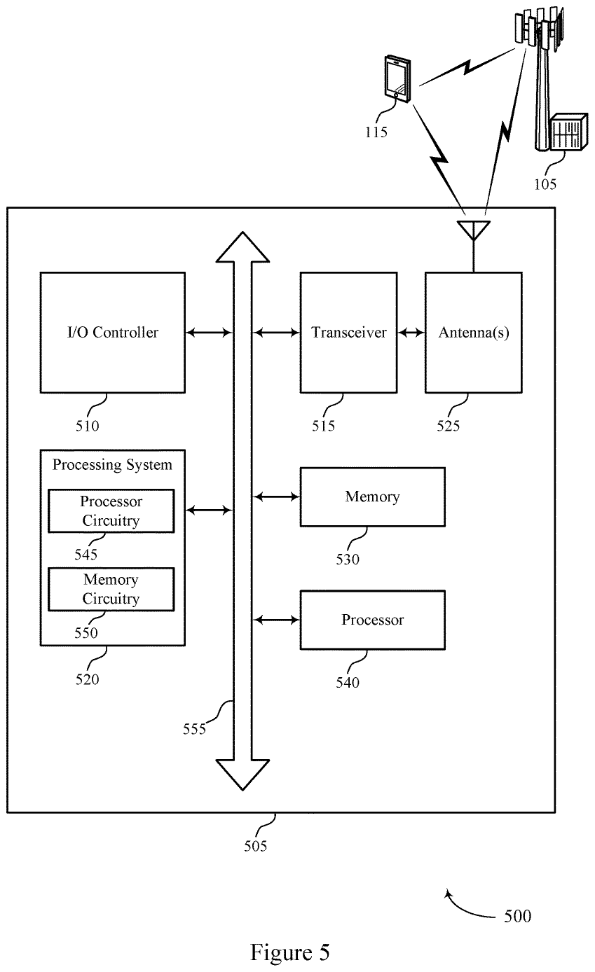

FIG. 5 shows an example of a system 500 including a device 505 that supports LBRM for multicast. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support limited buffer rate matching for multicast. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, the device 505 may support techniques for improved communication reliability and reduced latency for multicast reception.

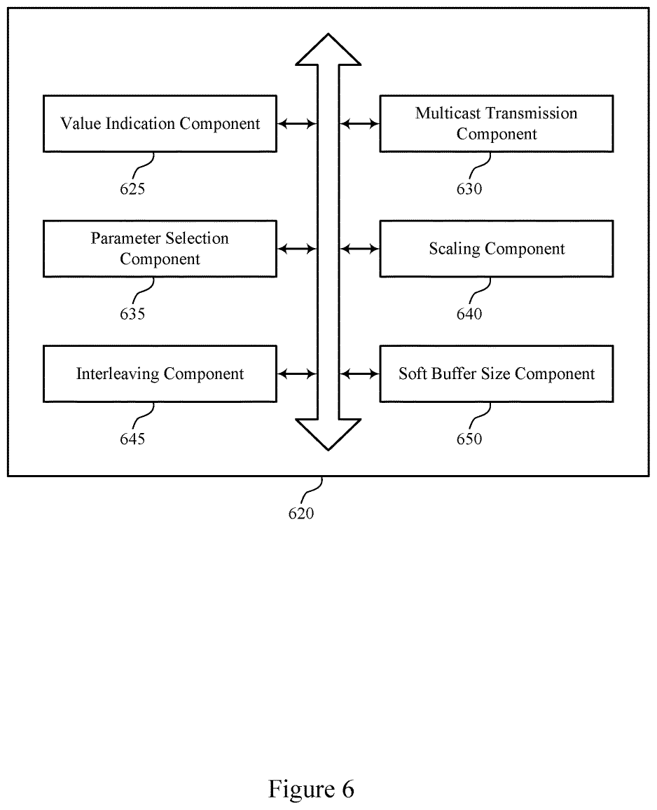

FIG. 6 shows an example of a processing system 620 that supports LBRM for multicast. A processing system 620 may be an example of a processing system 145 (such as network entity 105) and may include a value indication component 625, a multicast transmission component 630, a parameter selection component 635, a scaling component 640, an interleaving component 645, a soft buffer size component 650, or any combination thereof. A processing system 620, or various component thereof, may be an example of means for performing (such as a means for causing a network entity 105 to perform) various techniques described herein.

The value indication component 625 may be configured to cause the network entity 105 to transmit an indication of a value associated with LBRM for a multicast channel. The multicast transmission component 630 may be configured to cause the network entity 105 to transmit, via the multicast channel, a multicast or broadcast message, where the multicast or broadcast message is transmitted based on rate matching the multicast or broadcast message based on the value.

In some examples, the parameter selection component 635 may be configured to cause the network entity 105 to select one or more rate matching parameters based on the value, where the multicast or broadcast message is transmitted further based on the one or more rate matching parameters.

In some examples, the value includes at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.

In some examples, the soft buffer size component 650 may be configured to cause the network entity 105 to set a soft buffer size equal to at least one of the first soft buffer size or the second soft buffer size, where the rate matching the multicast or broadcast message is based on the soft buffer size.

In some examples, the soft buffer size component 650 may be configured to cause the network entity 105 to calculate a soft buffer size based on at least one of the total quantity of soft channel bits, or the first soft buffer size, or the second soft buffer size, or the threshold TBS, or the threshold coding rate, where the rate matching the multicast or broadcast message is based on the soft buffer size.

In some examples, the indication of the value includes a subfield with a bit value that indicates the value.

In some examples, the indication of the value includes at least one of a first indication associated with a candidate UE category or a second indication associated with a candidate UE capability.

In some examples, the indication of the value includes an index value. In some examples, the index value indicates the value based on a lookup table.

In some examples, the indication of the value is associated with a first physical multicast channel and the multicast channel includes the first physical multicast channel. In some examples, the indication of the value is associated with a first multimedia broadcast multicast service session and the multicast or broadcast message is associated with the first multimedia broadcast multicast service session.

In some examples, the value indication component 625 may be configured to cause the network entity 105 to transmit a second indication of a second value associated with the LBRM for at least one of a second physical multicast channel or a second multimedia broadcast multicast service session, where the second value is different from the first value.

In some examples, the indication of the value is transmitted via at least one of a SIB, or an MCCH message, or an MSI MAC-CE message.

In some examples, the scaling component 640 may be configured to cause the network entity 105 to scale a TBS for the multicast channel based on a first factor. In some examples, the interleaving component 645 may be configured to cause the network entity 105 to interleave a quantity of transport blocks in a time domain based on a second factor, where the multicast or broadcast message is transmitted based on the scaling and the interleaving.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for improved communication reliability, reduced latency, more efficient utilization of communication resources, and improved coordination between devices.

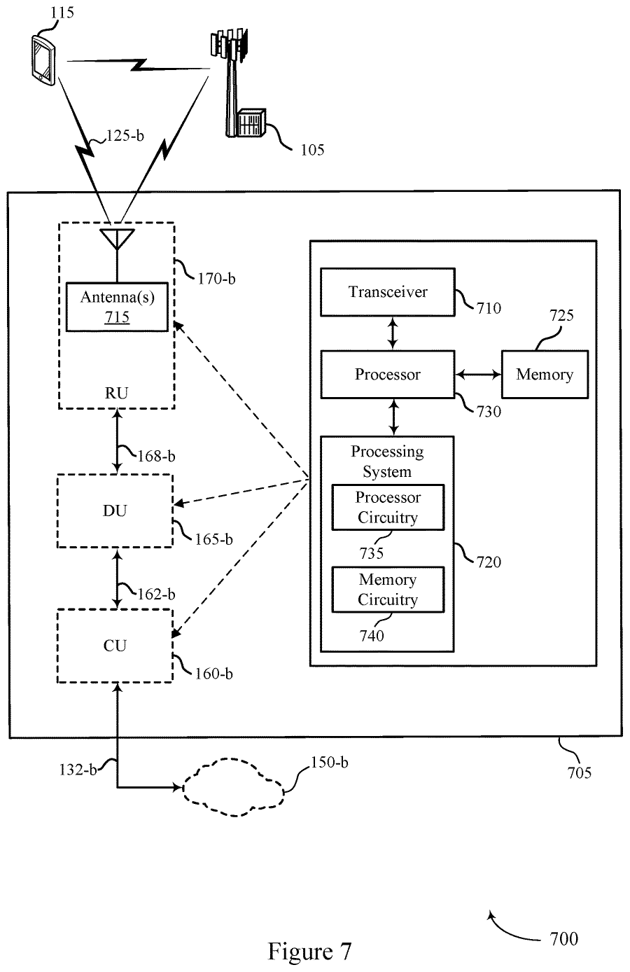

FIG. 7 shows an example of a system 700 including a device 705 that supports LBRM for multicast. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 620. For example, the processing system 720 may include processor circuitry 735 and memory circuitry 740 that stores code, and the processing system 720 may be configured to cause the device 705 to perform operations that support limited buffer rate matching for multicast. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, the device 705 may support techniques for improved communication reliability and reduced latency for multicast transmission.

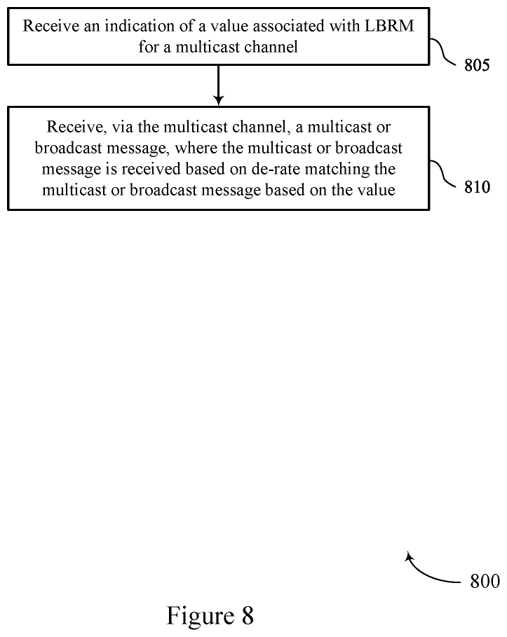

FIG. 8 shows an example of a method 800 that supports LBRM for multicast. Operations of the method 800 may be performed by a UE 115 or its components (such as using a processing system configured to cause the UE 115 to perform one or more of the operations) as described herein.

At 805, the method may include receiving an indication of a value (e.g., one or more values) associated with LBRM for a multicast channel. In some examples, aspects of the operations of 805 may be performed by a value indication component 425.

At 810, the method may include receiving, via the multicast channel, a multicast or broadcast message, where the multicast or broadcast message is received based on de-rate matching the multicast or broadcast message based on the value (e.g., the one or more values). In some examples, aspects of the operations of 810 may be performed by a multicast reception component 430.

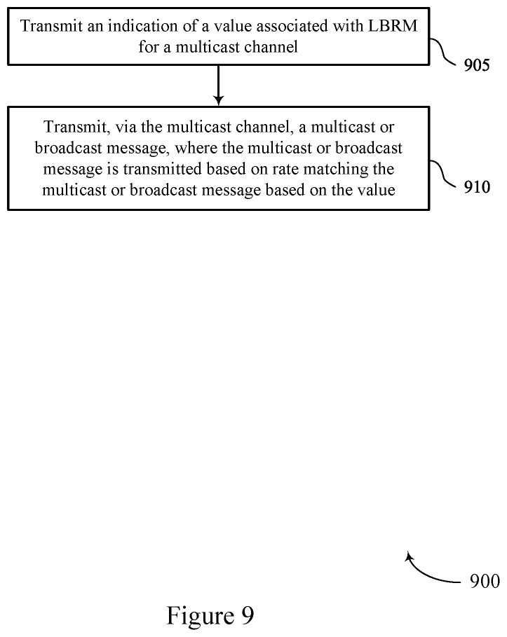

FIG. 9 shows an example of a method 900 that supports LBRM for multicast. Operations of the method 900 may be performed by a network entity 105 or its components (such as using a processing system configured to cause the network entity 105 to perform one or more operations) as described herein.

At 905, the method may include transmitting an indication of a value associated with LBRM for a multicast channel. In some examples, aspects of the operations of 905 may be performed by a value indication component 625.

At 910, the method may include transmitting, via the multicast channel, a multicast or broadcast message, where the multicast or broadcast message is transmitted based on rate matching the multicast or broadcast message based on the value. In some examples, aspects of the operations of 910 may be performed by a multicast transmission component 630.

Implementation examples are described in the following numbered clauses:
Aspect 1: A method for wireless communication at a UE, comprising: receiving an indication of one or more values associated with LBRM for a multicast channel; and receiving, via the multicast channel, a multicast or broadcast message, wherein the multicast or broadcast message is received based at least in part on de-rate matching the multicast or broadcast message based at least in part on the one or more values.
Aspect 2: The method of aspect 1, further comprising: selecting one or more de-rate matching parameters based at least in part on the indication of the value, wherein the multicast or broadcast message is de-rate matched further based at least in part on the one or more de-rate matching parameters.
Aspect 3: The method of any of aspects 1 through 2, wherein the value comprises at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.
Aspect 4: The method of aspect 3, further comprising: setting a soft buffer size equal to at least one of the first soft buffer size or the second soft buffer size, wherein the de-rate matching the multicast or broadcast message is based at least in part on the soft buffer size.
Aspect 5: The method of aspect 3, further comprising: calculating a soft buffer size based at least in part on at least one of the total quantity of soft channel bits, or the first soft buffer size, or the second soft buffer size, or the threshold TBS, or the threshold coding rate, wherein the de-rate matching the multicast or broadcast message is based at least in part on the soft buffer size.
Aspect 6: The method of any of aspects 1 through 5, wherein the indication of the value comprises a subfield with a bit value that indicates the value.
Aspect 7: The method of any of aspects 1 through 5, wherein the indication of the value comprises at least one of a first indication associated with a candidate UE category or a second indication associated with a candidate UE capability.
Aspect 8: The method of aspect 7, wherein the UE is associated with at least one of a first UE category different from the candidate UE category or a first UE capability different from the candidate UE capability.
Aspect 9: The method of any of aspects 1 through 5, wherein the indication of the value comprises an index value; and the index value indicates the value based at least in part on a lookup table.
Aspect 10: The method of any of aspects 1 through 9, wherein the indication of the value is associated with a first physical multicast channel and the multicast channel comprises the first physical multicast channel; or the indication of the value is associated with a first multimedia broadcast multicast service session and the multicast or broadcast message is associated with the first multimedia broadcast multicast service session.
Aspect 11: The method of aspect 10, further comprising: receiving a second indication of a second value associated with the LBRM for at least one of a second physical multicast channel or a second multimedia broadcast multicast service session, wherein the second value is different from the first value.
Aspect 12: The method of any of aspects 1 through 11, wherein the indication of the value is received via at least one of a SIB, or an MCCH message, or an MSI MAC-CE message.
Aspect 13: The method of any of aspects 1 through 12, wherein the multicast or broadcast message is interleaved in a time domain based at least in part on a set of time interleaving parameters.
Aspect 14: A method for wireless communication at a network entity, comprising: transmitting an indication of a value associated with LBRM for a multicast channel; and transmitting, via the multicast channel, a multicast or broadcast message, wherein the multicast or broadcast message is transmitted based at least in part on rate matching the multicast or broadcast message based at least in part on the value.
Aspect 15: The method of aspect 14, further comprising: selecting one or more rate matching parameters based at least in part on the value, wherein the multicast or broadcast message is transmitted further based at least in part on the one or more rate matching parameters.
Aspect 16: The method of any of aspects 14 through 15, wherein the value comprises at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.
Aspect 17: The method of aspect 16, further comprising: setting a soft buffer size equal to at least one of the first soft buffer size or the second soft buffer size, wherein the rate matching the multicast or broadcast message is based at least in part on the soft buffer size.
Aspect 18: The method of aspect 16, further comprising: calculating a soft buffer size based at least in part on at least one of the total quantity of soft channel bits, or the first soft buffer size, or the second soft buffer size, or the threshold TBS, or the threshold coding rate, wherein the rate matching the multicast or broadcast message is based at least in part on the soft buffer size.
Aspect 19: The method of any of aspects 14 through 18, wherein the indication of the value comprises a subfield with a bit value that indicates the value.
Aspect 20: The method of any of aspects 14 through 18, wherein the indication of the value comprises at least one of a first indication associated with a candidate UE category or a second indication associated with a candidate UE capability.
Aspect 21: The method of any of aspects 14 through 18, wherein the indication of the value comprises an index value; and the index value indicates the value based at least in part on a lookup table.
Aspect 22: The method of any of aspects 14 through 21, wherein the indication of the value is associated with a first physical multicast channel and the multicast channel comprises the first physical multicast channel; or the indication of the value is associated with a first multimedia broadcast multicast service session and the multicast or broadcast message is associated with the first multimedia broadcast multicast service session.
Aspect 23: The method of aspect 22, further comprising: transmitting a second indication of a second value associated with the LBRM for at least one of a second physical multicast channel or a second multimedia broadcast multicast service session, wherein the second value is different from the first value.
Aspect 24: The method of any of aspects 14 through 23, wherein the indication of the value is transmitted via at least one of a SIB, or an MCCH message, or an MSI MAC-CE message.
Aspect 25: The method of any of aspects 14 through 24, further comprising: scaling a TBS for the multicast channel based at least in part on a first factor; and interleaving a quantity of transport blocks in a time domain based at least in part on a second factor, wherein the multicast or broadcast message is transmitted based at least in part on the scaling and the interleaving.
Aspect 26: A UE for wireless communication, comprising a processing system that includes processor circuitry and memory circuitry that stores code, the processing system configured to cause the UE to perform a method of any of aspects 1 through 13.
Aspect 27: A UE for wireless communication, comprising at least one means for performing a method of any of aspects 1 through 13.
Aspect 28: A non-transitory computer-readable medium storing code for wireless communication, the code comprising instructions executable by one or more processors to perform a method of any of aspects 1 through 13.
Aspect 29: A network entity for wireless communication, comprising a processing system that includes processor circuitry and memory circuitry that stores code, the processing system configured to cause the network entity to perform a method of any of aspects 14 through 25.
Aspect 30: A network entity for wireless communication, comprising at least one means for performing a method of any of aspects 14 through 25.
Aspect 31: A non-transitory computer-readable medium storing code for wireless communication, the code comprising instructions executable by one or more processors to perform a method of any of aspects 14 through 25.

Additional implementation examples are described in the following numbered clauses:
Aspect 1: A method for wireless communication at a UE, comprising: receiving an indication of one or more values associated with LBRM for a multicast channel; and receiving, via the multicast channel, a multicast or broadcast message, wherein the multicast or broadcast message is received based at least in part on de-rate matching the multicast or broadcast message based at least in part on the one or more values.
Aspect 2: The method of aspect 1, further comprising: selecting one or more de-rate matching parameters based at least in part on the indication of the one or more values, wherein the multicast or broadcast message is de-rate matched further based at least in part on the one or more de-rate matching parameters.
Aspect 3: The method of any of aspects 1 through 2, wherein the indication of the one or more values comprises at least one of a first indication associated with a candidate UE category or a second indication associated with a candidate UE capability.
Aspect 4: The method of aspect 3, wherein the UE is associated with at least one of a first UE category different from the candidate UE category or a first UE capability different from the candidate UE capability.
Aspect 5: The method of any of aspects 1 through 4, wherein the multicast or broadcast message is interleaved in a time domain based at least in part on a set of time interleaving parameters.
Aspect 6: The method of any of aspects 1 through 5, wherein the one or more values comprise at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.
Aspect 7: The method of aspect 6, further comprising: setting a soft buffer size equal to at least one of the first soft buffer size or the second soft buffer size, wherein the de-rate matching the multicast or broadcast message is based at least in part on the soft buffer size.
Aspect 8: The method of aspect 6, further comprising: calculating a soft buffer size based at least in part on at least one of the total quantity of soft channel bits, or the first soft buffer size, or the second soft buffer size, or the threshold TBS, or the threshold coding rate, wherein the de-rate matching the multicast or broadcast message is based at least in part on the soft buffer size.
Aspect 9: The method of any of aspects 1 through 8, wherein the indication of the one or more values comprises one or more subfields with one or more bit values that indicates the one or more values.
Aspect 10: The method of any of aspects 1 through 9, wherein the indication of the one or more values comprises an index value; and the index value indicates the one or more values based at least in part on a lookup table.
Aspect 11: The method of any of aspects 1 through 10, wherein the indication of the one or more values is associated with a first physical multicast channel and the multicast channel comprises the first physical multicast channel; or the indication of the one or more values is associated with a first multimedia broadcast multicast service session and the multicast or broadcast message is associated with the first multimedia broadcast multicast service session.
Aspect 12: The method of aspect 11, further comprising: receiving a second indication of a second value associated with the LBRM for at least one of a second physical multicast channel or a second multimedia broadcast multicast service session, wherein the second value is different from the one or more values.
Aspect 13: The method of any of aspects 1 through 12, wherein the indication of the one or more values is received via at least one of a SIB, or an MCCH message, or an MSI MAC-CE message.
Aspect 14: A method for wireless communication at a network entity, comprising: transmitting an indication of one or more values associated with LBRM for a multicast channel; and transmitting, via the multicast channel, a multicast or broadcast message, wherein the multicast or broadcast message is transmitted based at least in part on rate matching the multicast or broadcast message based at least in part on the one or more values.
Aspect 15: The method of aspect 14, further comprising: selecting one or more rate matching parameters based at least in part on the one or more values, wherein the multicast or broadcast message is transmitted further based at least in part on the one or more rate matching parameters.
Aspect 16: The method of any of aspects 14 through 15, wherein the indication of the one or more values comprises at least one of a first indication associated with a candidate UE category or a second indication associated with a candidate UE capability.
Aspect 17: The method of any of aspects 14-16, wherein the multicast or broadcast message is interleaved in a time domain based at least in part on a set of time interleaving parameters
Aspect 18: The method of any of aspects 14 through 17, wherein the one or more values comprises at least one of a total quantity of soft channel bits, or a first soft buffer size associated with a transport block, or a second soft buffer size associated with a code block of the transport block, or a threshold TBS associated with the LBRM, or a threshold coding rate associated with the LBRM.
Aspect 19: The method of aspect 18, further comprising: calculating a soft buffer size based at least in part on at least one of the total quantity of soft channel bits, or the first soft buffer size, or the second soft buffer size, or the threshold TBS, or the threshold coding rate, wherein the rate matching the multicast or broadcast message is based at least in part on the soft buffer size.
Aspect 20: The method of aspect 18, further comprising: setting a soft buffer size equal to at least one of the first soft buffer size or the second soft buffer size, wherein the rate matching the multicast or broadcast message is based at least in part on the soft buffer size.
Aspect 21: The method of any of aspects 14 through 20, wherein the indication of the one or more values comprises one or more subfields with one or more bit values that indicates the one or more values.
Aspect 22: The method of any of aspects 14 through 21, wherein the indication of the one or more values comprises an index value; and the index value indicates the one or more values based at least in part on a lookup table.
Aspect 23: The method of any of aspects 14 through 22, wherein the indication of the one or more values is associated with a first physical multicast channel and the multicast channel comprises the first physical multicast channel; or the indication of the one or more values is associated with a first multimedia broadcast multicast service session and the multicast or broadcast message is associated with the first multimedia broadcast multicast service session.
Aspect 24: The method of aspect 23, further comprising: transmitting a second indication of a second value associated with the LBRM for at least one of a second physical multicast channel or a second multimedia broadcast multicast service session, wherein the second value is different from the one or more values.
Aspect 25: The method of any of aspects 14 through 24, wherein the indication of the one or more values is transmitted via at least one of a SIB, or an MCCH message, or an MSI MAC-CE message.
Aspect 26: The method of any of aspects 14 through 25, further comprising: scaling a TBS for the multicast channel based at least in part on a first factor; and interleaving a quantity of transport blocks in a time domain based at least in part on a second factor, wherein the multicast or broadcast message is transmitted based at least in part on the scaling and the interleaving.
Aspect 27: A UE for wireless communication, comprising a processing system that includes processor circuitry and memory circuitry that stores code, the processing system configured to cause the UE to perform a method of any of aspects 1 through 13.
Aspect 28: A UE for wireless communication, comprising at least one means for performing a method of any of aspects 1 through 13.
Aspect 29: A non-transitory computer-readable medium storing code for wireless communication, the code comprising instructions executable by one or more processors to perform a method of any of aspects 1 through 13.
Aspect 30: A network entity for wireless communication, comprising a processing system that includes processor circuitry and memory circuitry that stores code, the processing system configured to cause the network entity to perform a method of any of aspects 14 through 26.
Aspect 31: A network entity for wireless communication, comprising at least one means for performing a method of any of aspects 14 through 26.
Aspect 32: A non-transitory computer-readable medium storing code for wireless communication, the code comprising instructions executable by one or more processors to perform a method of any of aspects 14 through 26.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive an indication of one or more values associated with limited buffer rate matching (LBRM) for a multicast channel; and
receive, via the multicast channel, a multicast or broadcast message,
wherein the multicast or broadcast message is received based at least in part on de-rate matching the multicast or broadcast message based at least in part on the one or more values.

2. The UE of claim 1, wherein the processing system is further configured to cause the UE to:
select one or more de-rate matching parameters based at least in part on the indication of the one or more values,
wherein the multicast or broadcast message is de-rate matched further based at least in part on the one or more de-rate matching parameters.

3. The UE of claim 1, wherein the indication of the one or more values comprises at least one of a first indication associated with a candidate UE category or a second indication associated with a candidate UE capability.

4. The UE of claim 3, wherein the UE is associated with at least one of a first UE category different from the candidate UE category or a first UE capability different from the candidate UE capability.

5. The UE of claim 1, wherein the multicast or broadcast message is interleaved in a time domain based at least in part on a set of time interleaving parameters.

6. The UE of claim 1, wherein the one or more values is at least one of:
a total quantity of soft channel bits,
a first soft buffer size associated with a transport block,
a second soft buffer size associated with a code block of the transport block,
a threshold transport block size (TBS) associated with the LBRM, or
a threshold coding rate associated with the LBRM.

7. The UE of claim 6, wherein the processing system is further configured to cause the UE to:
set a soft buffer size equal to at least one of the first soft buffer size or the second soft buffer size,
wherein the de-rate matching the multicast or broadcast message is based at least in part on the soft buffer size.

8. The UE of claim 6, wherein the processing system is further configured to cause the UE to:
calculate a soft buffer size based at least in part on at least one of:
the total quantity of soft channel bits,
the first soft buffer size,
the second soft buffer size,
the threshold TBS, or
the threshold coding rate,
wherein the de-rate matching the multicast or broadcast message is based at least in part on the soft buffer size.

9. The UE of claim 1, wherein the indication of the one or more values comprises one or more subfields with one or more bit values that indicate the one or more values.

10. The UE of claim 1, wherein:
the indication of the one or more values comprises an index value; and
the index value indicates the one or more values based at least in part on a lookup table.

11. The UE of claim 1, wherein:
the indication of the one or more values is associated with a first physical multicast channel and the multicast channel comprises the first physical multicast channel; or
the indication of the one or more values is associated with a first multimedia broadcast multicast service session and the multicast or broadcast message is associated with the first multimedia broadcast multicast service session.

12. The UE of claim 11, wherein the processing system is further configured to cause the UE to:
receive a second indication of a second value associated with the LBRM for at least one of a second physical multicast channel or a second multimedia broadcast multicast service session,
wherein the second value is different from the one or more values.

13. The UE of claim 1, wherein the indication of the one or more values is received via at least one of a system information block (SIB), or a multicast control channel (MCCH) message, or a multicast channel scheduling information (MSI) medium access control (MAC) control element (CE) message.

14. A network entity, comprising:
a processing system that includes processor circuitry and memory circuitry that stores code, the processing system configured to cause the network entity to:
transmit an indication of one or more values associated with limited buffer rate matching (LBRM) for a multicast channel; and
transmit, via the multicast channel, a multicast or broadcast message,
wherein the multicast or broadcast message is transmitted based at least in part on rate matching the multicast or broadcast message based at least in part on the one or more values.

15. The network entity of claim 14, wherein the processing system is further configured to cause the network entity to:
select one or more rate matching parameters based at least in part on the one or more values,
wherein the multicast or broadcast message is rate matched further based at least in part on the one or more rate matching parameters.

16. The network entity of claim 14, wherein the indication of the one or more values comprises at least one of a first indication associated with a candidate UE category or a second indication associated with a candidate UE capability.

17. The network entity of claim 14, wherein the multicast or broadcast message is interleaved in a time domain based at least in part on a set of time interleaving parameters.

18. The network entity of claim 14, wherein the one or more values is at least one of:
a total quantity of soft channel bits,
a first soft buffer size associated with a transport block,
a second soft buffer size associated with a code block of the transport block,
a threshold transport block size (TBS) associated with the LBRM, or
a threshold coding rate associated with the LBRM.

19. The network entity of claim 18, wherein the processing system is further configured to cause the network entity to:
set a soft buffer size equal to at least one of the first soft buffer size or the second soft buffer size,
wherein the rate matching the multicast or broadcast message is based at least in part on the soft buffer size.

20. A method for wireless communication at a user equipment (UE), comprising:
receiving an indication of one or more values associated with limited buffer rate matching (LBRM) for a multicast channel; and
receiving, via the multicast channel, a multicast or broadcast message,
wherein the multicast or broadcast message is received based at least in part on de-rate matching the multicast or broadcast message based at least in part on the one or more values.
